(19) United States
(12) Patent Application Publication
(10) Pub. No.: US 2022/0214104 A1
(43) Pub. Date: Jul. 7, 2022

(54) METHOD FOR EXTRACTING NITROGEN FROM A NATURAL GAS STREAM OR A BIO-METHANE GAS STREAM CONTAINING ACID GASES

(71) Applicant: L'Air Liquide, Société Anonyme Pour l'Etude et l'Exploitation des Precédés Georges Claude, Paris (FR)

(72) Inventors: Marine ANDRICH, Jouy-en-Josas (FR); Oumar KHAN, Villemomble (FR); Paul TERRIEN, Woburn, MA (US)

(21) Appl. No.: 17/603,408

(22) PCT Filed: Mar. 5, 2020
(86) PCT No.: PCT/FR2020/050448

§ 371 Date: Oct. 13, 2021

(30) Foreign Application Priority Data
Apr. 16, 2019 (FR) 1904030

(51) Int. Cl. F25J 3/02; B01D 5/00

(52) U.S. Cl. CPC F25J 3/0257; F25J 3/0209; F25J 3/0233; F25J 3/0266; B01D 5/006; F25J 2235/60; F25J 2205/04; F25J 2210/04; F25J 2210/60; F25J 2220/66; F25J 2200/04

(57) ABSTRACT

Process for extracting nitrogen from a feed stream of natural gas or of biomethane comprising at least nitrogen, methane, CO₂ and/or H₂S, wherein a liquid stream enriched in methane resulting from a cryogenic separation is recovered by pumping the bottom product of one or more of the columns and/or pumping a liquid stream to a pressure P2 greater than 25 bar absolute and preferably greater than the critical pressure of said product.

### CROSS REFERENCE TO RELATED APPLICATIONS

This application is a 371 of International Application No. PCT/FR2020/050448, filed Mar. 5, 2020, which claims priority to French Patent Application No. 1904030, filed Apr. 16, 2019, the entire contents of which are incorporated herein by reference.

### BACKGROUND

The subject of the invention is a process for extracting nitrogen from a feed stream of natural gas or of biomethane (potentially derived from biogas) comprising at least nitrogen, methane, CO₂ and/or H₂S.

Crude natural gas or biomethane may contain a large number of troublesome impurities to be removed. Nitrogen is an example of said impurities. From a certain concentration of nitrogen in natural gas or in biomethane, said natural gas or biomethane is typically not marketable due to its low gross calorific value or else simply because of a limitation on the amount of inert gases, of which nitrogen forms part, in the natural gas or in the biomethane. In order to remove the nitrogen, use is generally made of a cryogenic process carried out in a unit known as Nitrogen Rejection Unit (NRU).

In some situations, natural gas or biomethane contains acid gases, such as CO₂ and/or H₂S. These acid gases are generally extracted from the natural gas or biomethane during a pretreatment step upstream of the nitrogen rejection unit.

Document U.S. Pat. No. 5,486,227 describes a process for the purification and liquefaction of a gas mixture which consists in subjecting the stream to a temperature swing adsorption (TSA), in order to remove the H₂S in particular, then to a pressure swing adsorption (PSA), in order to remove the CO₂ in particular, and then finally to a cryogenic separation, in order to remove the nitrogen and to retain only the methane.

Documents U.S. Pat. No. 3,989,478 and FR 2 917 489 describe cryogenic systems for the purification of a methane-rich stream. These two systems use an adsorption system in order to get rid of the CO₂ before the liquefaction step.

Usually, the nitrogen rejection units contain several distillation columns in order to optimize the energy consumption.

The nitrogen rejection units are often, for example, based on “double-column” systems. In systems of this type, a portion of the distillation is carried out at low pressure and low temperatures. The problem with these low temperatures is that the acid gases, such as CO₂ and/or H₂S, can freeze in the equipment if they are not removed. This is the reason why these acid gases are removed during an upstream pretreatment step. Some nitrogen rejection units are tolerant to a certain content of CO₂ but are then limited to a content generally not exceeding a few hundred ppm.

One of the problems which the invention thus intends to solve is that of providing a process for extracting nitrogen from a stream of natural gas or of biomethane containing high contents of acid gases while being exempted from an upstream pretreatment step.

The inventors of the present invention have thus developed a solution which makes it possible to solve the problems raised above.

### SUMMARY

A subject of the present invention is a process for extracting nitrogen from a feed stream of natural gas or of biomethane comprising at least nitrogen, methane, CO₂ and/or H₂S, comprising the following steps:

Step a): introduction of the feed gas stream into a refrigeration unit comprising at least one main exchanger, in which unit said gas stream is at least partially condensed;

Step b): the gas stream from step a) is introduced into a phase-separating means in order to produce a gas stream and a liquid stream;

Step c): the gas stream from step b) is introduced at a pressure P into a first cryogenic separation means comprising at least one distillation column, preferably only one, in order to separate the CO₂ and/or the H₂S, and a portion of the nitrogen at the top of said at least one column in order to obtain a stream at the column top, purified with respect to CO₂ and/or H₂S, and a column bottom liquid stream.

Step d): at least a portion of the gas produced at the top of said at least one column, resulting from step c), is introduced at a pressure P1 into a second cryogenic separation means comprising at least one distillation column, preferably only one, in order to separate the methane and nitrogen from the gas produced at the top of said column of the first cryogenic separation means, resulting from step c).

Step e) a liquid stream enriched in methane resulting from the cryogenic separation carried out during step d) is recovered at the bottom of said column of the second cryogenic separation means,

characterized in that P is greater than 25 bar abs and preferentially than 34 bar abs and P1 is less than 34 bar absolute, and in that, during step e), said liquid stream enriched in CH₄ resulting from the cryogenic separation is recovered by pumping the bottom product of one or more of the columns of step e) and/or pumping said liquid stream from step b) and/or c) to a pressure P2 greater than 25 bar absolute and preferably greater than the critical pressure of said product.

According to other embodiments, a subject of the invention is also:
A process as defined above, characterized in that the liquid stream from step e) is pumped and then injected into said at least one column of the first cryogenic separation means above or at the level of the injection of gas stream introduced during step c).
A process as defined above, characterized in that the liquid stream from step e) is pumped and then vaporized in the main exchanger before being mixed with the gas stream from step b) and then injected into said at least one column of the first cryogenic separation means used during step c).
A process as defined above, characterized in that the processing temperature of step b) is greater than the gel point of CO₂ and/or H₂S of the composition of the gas stream, at the pressure P.
A process as defined above, characterized in that the liquid stream from step b) is pumped and then vaporized in the main exchanger or else injected at the bottom of said at least one column of the first cryogenic separation means used during step c).
A process as defined above, characterized in that said feed stream comprises at least 0.1 molar % of CO₂ and/or at least 0.1 molar % of H₂S and preferentially at least 0.5% of CO₂ and at least 0.5 molar % of H₂S.
A process as defined above, characterized in that the feed stream is not subjected to a pretreatment step intended to reduce the molar concentration of CO₂ and of H₂S below 0.1 molar %.
A process as defined above, characterized in that the feed stream is mixed with a stream richer in methane and having a lower CO₂ and/or H₂S content.

A process as defined above, characterized in that said refrigeration unit is fed by an external refrigeration cycle wherein a refrigerant fluid circulates in a closed loop.
A process as defined above, characterized in that said refrigeration cycle comprises the following steps:
   compression of the refrigerant fluid; then
   cooling and/or liquefaction of said compressed fluid in the main heat exchanger;
   expansion of at least a portion of said cooled fluid;
   vaporization of the expanded fluid.
A process as defined above, characterized in that said refrigerant fluid is chosen from methane, nitrogen, a mixture of the two and/or hydrocarbons having more than two carbon atoms.
A process as defined above, characterized in that said refrigerant fluid is chosen from: the streams produced during steps d) and/or e) and/or the streams depleted of CO₂ and/or H₂S during step c).

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 shows a process for extracting nitrogen from a feed stream 1 of natural gas or of biomethane comprising at least nitrogen, methane, CO₂ and/or H₂S, comprising the following steps:

Step a): introduction of the feed gas stream 1 into a refrigeration unit comprising at least one main exchanger 3, wherein unit said gas stream is at least partially condensed 2;

Step b): the gas stream from step a) is introduced into a phase-separating means 4 at a pressure P in order to produce a gas stream 5 and a liquid stream 6;

Step c): the gas stream from step b) potentially mixed 23 with another stream 7 is introduced at a pressure P or at a lower pressure into a first cryogenic separation means comprising at least one distillation column 8 in order to separate the hydrocarbons having more than two carbon atoms, and/or CO₂, and/or H₂S and potentially a portion of the nitrogen from said gas stream. The function of this first separation means is to obtain at the top 15 a gas stream containing mainly nitrogen and methane and traces of hydrocarbons having more than two carbon atoms, CO₂ and H₂S.

Step d): at least a portion of the gas 9 from the first means from the top 15 of step c) is introduced at a pressure P1 into a second cryogenic separation means comprising at least one distillation column 10 in order to separate the methane and the nitrogen from the gas from the first separation means. The function of the second separation means is to separate the gas stream from the first means into a stream enriched in methane and a stream enriched in nitrogen.

Step e) a liquid stream 11 enriched in CH₄, resulting from the cryogenic separation carried out during step d), which will potentially be pumped, is recovered at the bottom 18.

### DETAILED DESCRIPTION OF PREFERRED EMBODIMENTS

The solution which is a subject of the present invention is thus not to further reduce the content of CO₂ and/or H₂S in the gas to be treated, while providing a sufficient solubility of the CO₂ and/or H₂S in the gas to be treated (mainly methane and nitrogen) in order to prevent crystallization, this being the case at any point of the process.

The upstream pretreatment step to remove the majority of the CO₂ and/or the H₂S can therefore be eliminated.

According to other embodiments, a subject of the invention is also:

A process as defined above, characterized in that at least a portion 12 of the liquid stream from step c) is potentially pumped to a pressure P2 greater than 25 bar absolute and preferably greater than the critical pressure of said mixture.

The gas stream 13 from column 8 mainly containing nitrogen and methane and also traces of other components, in particular CO₂ and H₂S, is expanded to the pressure P1 and introduced into a second cryogenic separation means comprising the distillation column 10.

The cryogenic separation means comprising the distillation column 10 produces:
at the top 17 of column 10, a gas 16 enriched in nitrogen and depleted of methane, preferably below 1%;
at the bottom 18, a liquid stream 11, the composition of which is adjusted as a function of the cycle and/or of the composition of the stream 5 in order to reduce the risks of gelling.

The gas stream 19 is reheated in the main exchanger 3 to then be potentially compressed 20 at the outlet of the exchanger.

Alternatively, the stream 20 can be introduced into a turbine before or after it passes into the exchanger in order to recover its pressure energy in a booster which will be located upstream or downstream of the compressors 21 and/or 22.

In such an alternative embodiment, the liquid stream 11 produced at the bottom 18 of the second column 10 of the second separation means may be injected directly into the column 8 of the first cryogenic separation means without being vaporized in the exchanger 3. This stream 11 is introduced at the level of or above the feed gas stream 23.

The invention also relates to:
A process as defined above, characterized in that the processing temperature in any part of the process is greater than the gel point of CO₂ and/or H₂S of the composition of the streams involved, at their respective pressures.
A process as defined above, characterized in that said feed stream comprises at least 0.1 molar % of CO₂ and/or at least 0.1 molar % of H₂S.
A process as defined above, characterized in that the feed stream is not subjected to a pretreatment step intended to reduce the molar concentration of CO₂ and of H₂S below 0.1 molar %.
A process as defined above, characterized in that the pressure P2 is greater than 25 bar absolute.
A process as defined above, characterized in that said refrigeration unit is fed by an external refrigeration cycle wherein a refrigerant fluid circulates in a closed loop.
A process as defined above, characterized in that said refrigeration cycle comprises the following steps:
   compression of the refrigerant fluid; then
   cooling of said compressed fluid in the main heat exchanger and also in reboilers 24 and 25;
   a first expansion of at least a portion of said cooled fluid;
   vaporization of the expanded fluid;
   a second expansion of at least a portion of the remaining fluid;
   vaporization of the expanded fluid.
A process as defined above, characterized in that said refrigerant fluid is chosen from methane, nitrogen, a mixture of the two and/or hydrocarbons having more than two carbon atoms.
A process as defined above, characterized in that the vaporization step of the external refrigeration cycle is carried out at at least one pressure defined as a function of the pressures P and P1.

The heat exchanger may be any heat exchanger, any unit or other arrangement suitable for allowing the passage of a certain number of streams, and thus allowing direct or indirect heat exchange between one or more coolant fluid lines and one or more feed streams.

Advantageously, the facility implementing the process of the invention contains only two high-pressure distillation columns. Typically the pressure of the first column is greater than 25 bar absolute and preferentially greater than 34 bar absolute and that of the second is less than 34 bar absolute. Consequently, the frigories necessary for the condensation of the gas stream to be treated and for the production of the refluxes of the two columns have to be contributed by an external refrigeration cycle integrated into the facility which makes possible the implementation of the process which is a subject of the present invention.

The pressure and temperature conditions of this refrigeration cycle are determined in order to optimize the operating conditions of the main heat exchanger, as a function of the specifications of the products employed and also as a function of the operating pressures of the columns 8 and 10.

More specifically, the refrigeration cycle is an external refrigeration cycle consisting of the following steps:
Compression of the refrigerant fluid;
Cooling in a heat exchanger;
At least a portion of the cooled fluid is potentially at least partially condensed in indirect exchange with the reboilers of the distillation columns 8 and 10 (the outlet pressure of the cycle compressor is chosen in order to be able to carry out this condensation while minimizing the temperature difference in this exchanger);
At least a portion of the cooled fluid that has been condensed is expanded in at least one valve to at least one pressure and then vaporized in indirect exchange with the condenser of the distillation column.

The invention also relates to a process as defined above, characterized in that the composition of the external refrigeration cycle can be the composition of the stream 11 in the case of a closed cycle. This allows closed cycles—in which there are losses of fluids—to have a make-up directly from one of the process streams while avoiding an external provision.

The fluid can also, for example, be nitrogen at a supercritical pressure at the outlet of the compressor. In such a case, the cooling in indirect exchange with the reboiling of the column is not really a condensation as there is no longer a change in phase under these supercritical conditions. In such a case, a simple cooling, involving a significant change in density (at least 5%), should be understood.

Alternatively, the refrigeration cycle might equally well be open (that is to say, one of the products is used as fluid circulating in the refrigeration cycle).

For example, a refrigeration cycle with residual nitrogen resulting from the top of the column could be envisioned.

Alternatively, during step d), a “double-column” refrigeration unit comprising an “MP” column (that is to say wherein the pressure is preferentially between 20 and 25 bar abs) and an “LP” column (that is to say wherein the pressure is preferentially between 1 and 3 bar abs) is used. The reflux of the MP column and the reboiling of the LP column are integrated in a heat exchanger known as a vapor-reboiler which makes it possible to act both as a condenser and as a reboiler. The gas stream produced at the top of the LP column is a residual stream mainly containing nitrogen which will be vented to the atmosphere. The liquid stream at the bottom of the LP column containing mainly methane may be pumped and either mixed with the stream 5 and/or sent to the column 8 and/or upgraded as a product of the unit after being reheated in the exchanger 3.

This embodiment is particularly advantageous in the case where the nitrogen produced at the top of the column 10 is not upgraded. This makes it possible in particular to optimize the process by reducing the energy consumption of the external refrigeration cycle.

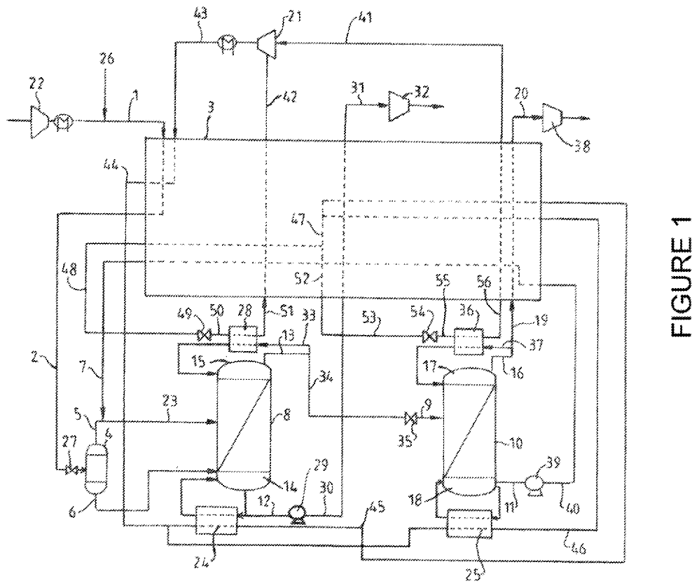

The invention will be described in a more detailed manner with reference to FIG. 1.

FIG. 1 illustrates a specific embodiment of a process according to the invention carried out by a facility as represented diagrammatically.

A liquid stream and the pipe which conveys it are denoted by one and the same reference, the pressures considered are absolute pressures and the percentages considered are molar percentages.

In FIG. 1, the facility comprises a source of natural gas or of biomethane 1, comprising at least methane, nitrogen, CO₂ and/or H₂S. Typically, the stream of natural gas or of biomethane from this source 1 comprises at least 40 molar % of nitrogen and at least 20 molar % of methane.

The natural gas stream 1 is introduced into a heat exchanger 3 after having been potentially compressed by a compressor 22 and/or mixed with a stream 26 rich in methane potentially containing nitrogen and low contents of CO₂ and/or of H₂S. The stream 26 can be mixed with the stream 1 before or after compression. Typically the stream 1 is at a pressure greater than 25 bar absolute and preferentially greater than 34 bar abs. The stream 1 is then cooled 2 in the heat exchanger 3 to a temperature between −50° C. and −100° C.

The stream 2 thus cooled is introduced into a liquid/gas phase-separating means 4. Beforehand, the stream 2 may have been subjected to a reduction in pressure in a pressure-reducing means 27, typically a valve. The phase-separating means 4 generates two streams, one gaseous 5 and the other liquid 6. The gas stream 5 is enriched in nitrogen and methane, while the liquid stream 6 is depleted of nitrogen and methane but enriched in heavier products, such as hydrocarbons having at least two carbon atoms and CO₂ and H₂S.

The gas stream 5 is mixed with the stream 7 containing essentially methane and nitrogen from the column 10, and the resulting stream 23 is introduced at an intermediate level into a distillation column 8 composed of plates (or of structured or non-structured packing) which are located between one end located at the bottom 14 and another end located at the top 15. Said column 8 comprises a condenser 28 and a reboiling means 24. The stream 23 is introduced into the column 8 at a pressure P typically greater than 25 bar absolute and preferentially greater than 34 bar abs. At the top 15 of the column 8, a stream 13 comprising at least 30 molar % of nitrogen and/or at least 40 molar % of methane, preferentially 45 molar % of nitrogen and/or 55 molar % of methane, is extracted at a temperature T1. This stream 13 now comprises only traces of CO₂, of H₂S, and of hydrocarbons heavier than methane. Typically, T1 is between −100° C. and −160° C.

At the bottom 14 of column 8, a liquid 12 is extracted which, relative to the feed stream 1, is enriched in methane and depleted of nitrogen and contains almost all of the CO₂, H₂S and hydrocarbons having more than two carbon atoms. The pressure of the liquid stream 12 is potentially increased via a pump 29 so as to obtain a stream 30 sent to the heat exchanger 3 in which it will be vaporized to obtain a stream 31, the pressure of which may be increased by a compressor 32.

A portion 33 of the stream 13 is introduced into the condenser 28 and is then sent to the column 8 as reflux. The other portion 34 of the stream 13 is expanded for example in a valve 35 to a pressure P1 less than 34 bar absolute. The stream 9 thus obtained is introduced at an intermediate level into the column 10 operating at a pressure P1 of less than 34 bar absolute.

Said column 10 is composed of trays (or structured or non-structured packing) located between an end located at the bottom 18 and the other end located at the top 17 and comprises a condenser 36 and a reboiler 25.

The stream 37 which is part of the stream 16 produced at the top 17 of the column 10 is introduced into the condenser 36 and then returned to the column 10 as reflux. The gas stream 16 typically contains 99 molar % of nitrogen and 1 molar % of methane and is at a temperature between −120° C. and −195° C. The stream 19 is introduced into the main heat exchanger 3 in order to be reheated 20 before being compressed in a compressor 38.

At the bottom 18 of the column 10, the stream 11 is produced which is depleted of nitrogen and enriched in methane relative to the stream 9. The pressure of the stream 11 is increased for example by means of a pump 39 in order to obtain a liquid stream 40 at a pressure P at least above 25 bar absolute and preferentially greater than 34 bar abs. The stream 40 is introduced into the main exchanger 3 so as to be vaporized 7 and mixed with the stream 5 in order to obtain the stream 23. The stream 23 thus formed has a higher mole fraction of methane and a lower mole fraction of nitrogen, of CO₂, of H₂S and hydrocarbons having more than two carbon atoms, relative to the stream 5.

The external refrigeration cycle contains at least one compressor 21 or a series of compressors having a suction gas stream 41 at low pressure (>1 bar abs) and also a medium-pressure stream 42 (>10 bar abs) introduced at an intermediate stage to give a stream resulting in the discharge 43 (at a pressure greater than the pressure P). The fluid 43 is introduced into the heat exchanger 3 and a single-phase or two-phase stream 44 is partially or totally extracted therefrom at a temperature between −50° C. and −100° C. The stream 44 is partially or totally introduced into the reboiler 24 and/or/then into the reboiler 25. The streams 45 and 46 thus obtained are reintroduced into the heat exchanger 3 to continue their cooling. A portion of the resulting stream 47 cooled to a temperature between −100° C. and −150° C. is then extracted 48 from the exchanger 3 and expanded by a valve 49 to a pressure determined as a function of the pressure P so as to produce a liquid or two-phase fluid 50 which will be partially or totally vaporized in the condenser 28 by heat exchange against the stream 33 which will be partially or totally liquefied. The stream 50 re-emerges from the condenser 28 to produce a stream 51 which will be reheated in the main exchanger 3 so as to produce the stream 42 which will be introduced into the compressor 21 in an intermediate stage.

The remaining portion 52 of the stream 47 continues to be cooled in the main exchanger 3 so as to produce a stream 53 at a temperature between −130° C. and −190° C. The stream 53 is expanded by a valve 54 at a pressure chosen as a function of P1 and giving rise to a liquid or two-phase stream 55. The stream 55 is introduced into the condenser 36 in order to partially or totally liquefy the stream 37. The partially or totally gaseous stream 56 which corresponds to the reheated stream 55 is introduced into the exchanger 3 so as to produce the stream 41 which is introduced into the compressor 21.

The process which is a subject of the present invention makes it possible to treat streams of natural gas or of biomethane of different qualities having more or less nitrogen and also several thousand molar ppm of acid gases, or even more than 1 molar % of acid gases.

Furthermore, the process which is a subject of the present invention makes it possible to treat a feed stream 1, the composition of which may vary over time, for example a stream which becomes richer in nitrogen and/or in CO₂ and/or H₂S.

The methane produced by the process which is a subject of the present invention can be pumped to very high pressure in order to observe the pressure of the gas pipeline into which it will be introduced, this being done while avoiding the addition of a compressor.

By way of example, the following Table 1 illustrates an implementation of the process according to the invention.

TABLE 1

| Stream | | 1 | 12 | 16 | 11 | 13 |
|---|---|---|---|---|---|---|
| N2 | molar % | 40.60% | 5.00% | 99.00% | <10% | 44.16% |
| CO₂ | | 1.35% | 2.17% | 0.00% | 0.00% | 0.00% |
| H₂S | | 1.13% | 1.82% | 0.00% | 0.00% | 0.00% |
| C1 | | 43.57% | 69.52% | 1.00% | >90% | 55.84% |
| C2 | | 7.09% | 11.41% | 0.00% | 0.00% | 0.00% |
| C3 | | 3.25% | 5.23% | 0.00% | 0.00% | 0.00% |
| i-C4 | | 0.50% | 0.80% | 0.00% | 0.00% | 0.00% |
| n-C4 | | 1.38% | 2.22% | 0.00% | 0.00% | 0.00% |
| i-C5 | | 0.29% | 0.47% | 0.00% | 0.00% | 0.00% |
| n-C5 | | 0.36% | 0.58% | 0.00% | 0.00% | 0.00% |
| C6 | | 0.48% | 0.77% | 0.00% | 0.00% | 0.00% |

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-12. (canceled)

13. A process for extracting nitrogen from a feed stream of natural gas or of biomethane comprising at least nitrogen, methane, CO₂ and/or H₂S, comprising:
a) introducing the feed gas stream into a refrigeration unit comprising at least one main exchanger, thereby producing an at least partially condensed stream;
b) introducing the at least partially condensed stream from a) into a phase-separating means in order to produce a gas stream and a liquid stream;
c) introducing the gas stream from b), at a pressure P, into a first cryogenic separation means comprising at least one distillation column in order to separate the CO₂ and/or the H₂S, and a portion of the nitrogen at the top of said at least one column in order to obtain a stream at the column top, purified with respect to CO₂ and/or H₂S, and a column bottom liquid stream,
d) introducing at least a portion of the gas produced at the top of said at least one column, resulting from c), at a pressure P1, into a second cryogenic separation means comprising at least one distillation column in order to separate the methane and nitrogen from the gas produced at the top of said column of the first cryogenic separation means, resulting from c).
e) recovering a liquid stream enriched in methane resulting from the cryogenic separation carried out during d) at the bottom of said column of the second cryogenic separation means,
wherein P is greater than 25 bar abs and P1 is less than 34 bar absolute, and wherein, during e), said liquid stream enriched in methane resulting from the cryogenic separation is recovered by pumping the bottom product of one or more of the columns used during e) and/or pumping said liquid stream from b) and/or c) to a pressure P2 greater than the critical pressure of said product.

14. The process as claimed in claim 13, wherein the liquid stream from e) is pumped and then injected into said at least one column of the first cryogenic separation means above or at the level of the injection of gas stream introduced during c).

15. The process as claimed in claim 14, wherein the liquid stream from e) is pumped and then vaporized in the main exchanger before being mixed with the gas stream from b) and then injected into said at least one column of the first cryogenic separation means used during c).

16. The process as claimed in claim 13, wherein the processing temperature of b) is greater than the gel point of CO₂ and/or H₂S of the composition of the gas stream, at the pressure P.

17. The process as claimed in claim 13, wherein the liquid stream from b) is pumped and then vaporized in the main exchanger or else injected at the bottom of said at least one column of the first cryogenic separation means used during c).

18. The process as claimed in claim 13, wherein said feed stream comprises at least 0.1 molar % of CO₂ and/or at least 0.1 molar % of H₂S.

19. The process as claimed in claim 13, wherein the feed stream is not subjected to a pretreatment step to reduce the molar concentration of CO₂ and of H₂S below 0.1 molar %.

20. The process as claimed in claim 13, wherein the feed stream is mixed with a stream richer in methane and having a lower CO₂ and/or H₂S content.

21. The process as claimed in claim 13, wherein said refrigeration unit is fed by an external refrigeration cycle wherein a refrigerant fluid circulates in a closed loop.

22. The process as claimed in claim 21, wherein said refrigeration cycle comprises the following:
compression of the refrigerant fluid; then
cooling and/or liquefaction of said compressed fluid in the main heat exchanger;
expansion of at least a portion of said cooled fluid;
vaporization of the expanded fluid.

23. The process as claimed in claim 21, wherein said refrigerant fluid is chosen from methane, nitrogen, a mixture of the two and/or hydrocarbons having more than two carbon atoms.

24. The process as claimed in claim 21, wherein said refrigerant fluid is chosen from: the streams produced during d) and/or e) and/or the streams depleted of CO₂ and/or H₂S during c).
